(19) United States
(12) Patent Application Publication
(10) Pub. No.: US 2008/0169642 A1
(43) Pub. Date: Jul. 17, 2008

(54) ABRASION-RESISTANT CERAMIC ELBOW

(76) Inventors: Changgui YANG, Changsha (CN); Zheng YANG, Changsha (CN); Bing YANG, Changsha (CN)

Correspondence Address: MATTHIAS SCHOLL, 14781 MEMORIAL DRIVE, SUITE 1319, HOUSTON, TX, 77079, US

(21) Appl. No.: 11/838,485

(22) Filed: Aug. 14, 2007

(30) Foreign Application Priority Data
Jan. 16, 2007 (CN) 200710034266.8

(51) Int. Cl. F16L 57/06; B65G 53/32

(52) U.S. Cl. 285/16; 414/800

(57) ABSTRACT

The invention discloses a spliced abrasion resistant ceramic elbow, wherein an abrasion resistant ceramic inner lining (4) is disposed on the inner surface of a seamless elbow body (1), and is formed by splicing a plurality of abrasion resistant ceramic tiles (2). The abrasion resistant ceramic tiles (2) are spliced along the circumferential direction to form an abrasion resistant ceramic ring (5) fitted with said seamless elbow body (1). A plurality of abrasion resistant ceramic rings (5) is connected along the axial direction to form an abrasion resistant ceramic inner lining (4) fitted with the seamless elbow body (1). The abrasion resistant ceramic elbow of the invention provides the advantages of good abrasion resistant capability, low brittleness and no shrinkage strain, simple structure, easy manufacture and assemble, low cost, and good reliability.

### CROSS-REFERENCE TO RELATED APPLICATIONS

Pursuant to 35 U.S.C. §119 and the Paris Convention Treaty, this application claims the benefit of Chinese Patent Application No. 200710034266.8 filed Jan. 16, 2007, the contents of which are incorporated herein by reference.

### BACKGROUND OF THE INVENTION

1. Field of the Invention

The invention relates to a pipe elbow, and more specifically, to a pipe elbow for transporting highly-abrasive concrete materials.

2. Description of the Related Art

During transport of concrete materials by concrete transporting pipes, excessive wear is a common problem, which is especially evident in the sections of pipe elbows. Generally, concrete transporting pipes have to face adverse operating factors in order to transport concrete materials to their destination, such as, high transportation height (the operating environment is generally 20-400 meters high); high hardness of concrete material, which generally contains large lime stones and gravels; and poor flowability of concrete material, which increases the pressure applied to the pipe elbow and aggravates the wear thereof.

The service lifetime of conventional steel elbow is short due to its limited abrasion resistant capability, and is generally 2-3 months (which is equivalent to transporting about 20000 m³ concrete materials). Accordingly, there is an urgent need to find a choice material having a good abrasion resistant capability and a long service lifetime to replace the conventional steel elbows in order to minimize the wear of the pipe elbow during the transportation of concrete materials.

### SUMMARY OF THE INVENTION

Therefore, it is one objective of the invention to provide a spliced abrasion resistant ceramic elbow having good abrasion resistant capability, low brittleness, long service lifetime, and no shrinkage strain.

To achieve the above objective, provided a spliced abrasion resistant ceramic elbow, comprising a seamless elbow body. An abrasion resistant ceramic inner lining is disposed on the seamless elbow body, and is formed by splicing a plurality of abrasion resistant ceramic tiles. Namely, the abrasion resistant ceramic tiles are spliced together along the circumferential direction to form an abrasion resistant ceramic bushing ring fitted with the seamless elbow body, a plurality of the abrasion resistant ceramic bushing rings are connected along the axial direction together to form the abrasion resistant ceramic inner lining fitted with the seamless elbow body. An end ring to block the abrasion resistant ceramic inner lining is disposed at each of the both ends of the seamless elbow body.

In certain embodiments of the invention, a high strength and high temperature resistant inorganic adhesive is filled in the gap between the seamless elbow body and the abrasion resistant ceramic inner lining.

In certain embodiments of the invention, the abrasion resistant ceramic inner lining is extended to the insides of the end rings to cover their inner surfaces.

In certain embodiments of the invention, the thickness of the outer bend having a large bending radius of the abrasion resistant ceramic inner lining is larger than that of the inner bend having a small bending radius of the abrasion resistant ceramic inner lining.

In accordance with the abrasion resistant ceramic elbow of the invention, the abrasion resistant capability of the pipe elbow is increased largely; the molding of monolithic pipe and the control of the manufacturing process owing to brittleness and shrinkage are solved effectively; and the service life of the pipe is prolonged. The material powder does not contain impurities such as iron, therefore, the product quality and the production efficiency are increased, and the manufacturing cost is decreased. The abrasion resistant ceramic elbow of the invention has the advantages of strong abrasion resistant capability, good stability and shock resistance performance. Most importantly, the ceramic elbow of the invention is eccentric, namely, the outer bend withstanding most wear of the ceramic inner lining is thicker than the inner bend of the ceramic lining. Therefore, the spliced abrasion resistant ceramic elbow has a 5-8 times longer service life compared to the conventional material.

As a result, the abrasion resistant ceramic elbow has a good abrasion resistant capability, low brittleness and no shrinkage strain, simple structure, low cost, and good reliability, and is easy to manufacture and assemble.

### BRIEF DESCRIPTION OF THE DRAWINGS

The objects and advantages of the invention will become more readily apparent after reading the ensuing descriptions of the non-limiting illustrative embodiment and viewing the accompanying drawings, in which

FIG. 1 is a structural view of a spliced abrasion resistant ceramic elbow according to one embodiment of the invention;

FIG. 2 is a cross sectional view along the A-A line of FIG. 1;

FIG. 3 is a structural view of a single abrasion-resistant ceramic tile according to one embodiment of the invention; and

FIG. 4 is an improved structural view of a spliced abrasion resistant ceramic elbow according to one embodiment of the invention.

### DETAILED DESCRIPTION OF THE EMBODIMENTS

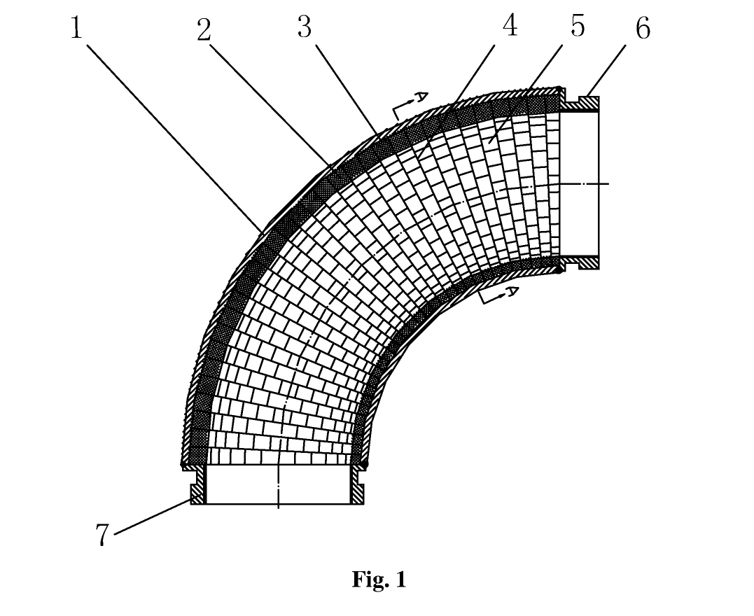

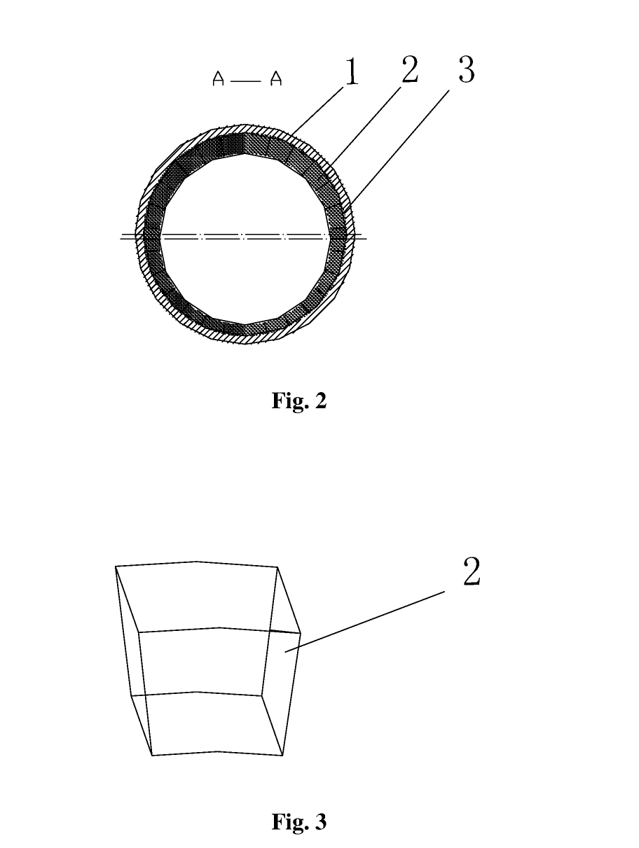

As shown in FIGS. 1-3, an abrasion-resistant ceramic inner lining 4 is disposed on the inner surface of a seamless elbow body 1, and is formed by splicing a plurality of abrasion resistant ceramic tiles 2. Namely, the abrasion resistant ceramic tiles 2 are spliced along the circumferential direction to form an abrasion-resistant ceramic ring 5 fitted with the seamless elbow body 1, and a plurality of abrasion resistant ceramic rings 5 are connected along the axial direction to form an abrasion resistant ceramic inner lining 4 fitted with the seamless elbow body 1. A first end ring 6 and a second end ring 7 blocking the abrasion resistant ceramic inner lining 4 are disposed at the both ends of the seamless elbow body.

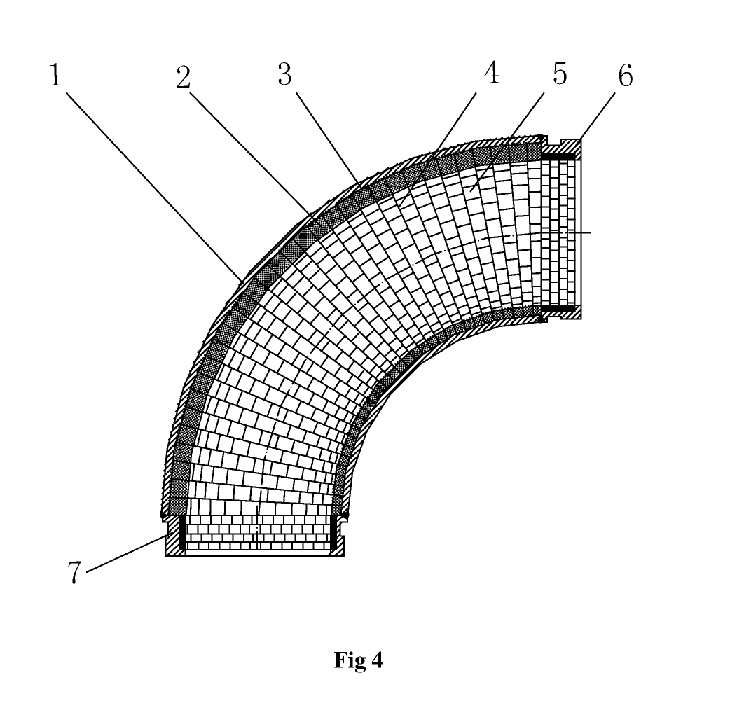

As shown in FIG. 4, the abrasion resistant ceramic inner lining 4 is extended all the way up to the first end ring 6 and the second end ring 7 to cover their inner surfaces. In addition, the outer bend having a larger bending radius of the abrasion resistant inner lining 4 is thicker than the inner bend having a smaller bending radius.

As illustrated in FIGS. 1-4, embodiments of the invention increase largely the abrasion resistant capability of steel transportation pipes. When transporting concrete materials of high hardness, the abrasion resistant ceramic inner lining 4 fitted on the inner surface of the elbow body can withstand effectively the shock from the flow of concrete materials, and thereby, the service lifetime of pipes is increased. Each abrasion resistant ceramic tile 2 making up the elbow is in a shape of a wedge. The abrasion-resistant ceramic inner lining 4 is formed by splicing the wedge shaped abrasion resistant ceramic tiles 2. Owing to the interaction between the abrasion resistant ceramic tiles 2, the abrasion resistant ceramic inner lining has a stable and reliable structure, and its two ends can be blocked effectively by the end rings. Compared to the conventional material, the spliced abrasion resistant ceramic elbow has a 5-8 times longer service lifetime.

As a further improvement, a high strength and/or high temperature resistant inorganic adhesive 3 is filled in the gap between the seamless elbow body 1 and the abrasion resistant ceramic inner lining 4, and serves to adhere the abrasion resistant ceramic inner lining 4 more reliably to the inner surface of the seamless elbow body 1.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

What is claimed is:

1. An abrasion-resistant ceramic elbow, comprising
a seamless elbow body (1) having an inner surface and an outer surface and having two ends;
an abrasion-resistant ceramic inner lining (4);
a plurality of abrasion-resistant ceramic tiles (2); and
a plurality of an abrasion-resistant ceramic rings (5);
wherein
said abrasion-resistant ceramic inner lining (4) is disposed on said inner surface of a seamless elbow body (1), and is formed by splicing a plurality of abrasion resistant ceramic tiles (2);
said abrasion-resistant ceramic tiles (2) are spliced along a circumferential direction to form said abrasion-resistant ceramic ring (5) fitted within said seamless elbow body (1);
a plurality of abrasion resistant ceramic rings (5) are connected along the axial direction to form an abrasion-resistant ceramic inner lining (4) fitted within the seamless elbow body (1); and
a pair of end rings (6, 7) blocking the abrasion resistant ceramic inner lining (4) is disposed at each of the both ends of said seamless elbow body.

2. The ceramic elbow of claim 1, further comprising a gap between said seamless elbow body (1) and said abrasion resistant ceramic inner lining (4), wherein a high strength and/or high temperature resistant inorganic adhesive (3) is filled in said gap between said seamless elbow body (1) and said abrasion resistant ceramic inner lining (4).

3. The ceramic elbow of claim 1, wherein said abrasion resistant ceramic inner lining (4) overlaps with said end rings (6, 7).

4. The ceramic elbow of claim 2, wherein said abrasion resistant ceramic inner lining (4) overlaps with said end rings (6, 7).

5. The ceramic elbow of claim 1, wherein said abrasion-resistant ceramic tiles (2) are in a shape of a wedge.

6. An abrasion-resistant ceramic elbow having an inner bend and an outer bend, comprising at least a first plurality of abrasion resistant ceramic tiles (2) having a first thickness and a second plurality of abrasion resistant ceramic tiles (2) having a second thickness, wherein said first thickness is greater than said second thickness; said first plurality of abrasion resistant ceramic tiles (2) having a first thickness is disposed at said inner bend, and said second plurality of abrasion resistant ceramic tiles (2) having a second thickness is disposed at said second bend.

7. The ceramic elbow of claim 6, wherein said abrasion-resistant ceramic tiles (2) are in a shape of a wedge.

8. A method of transporting concrete materials comprising providing transport pipes conjoined with one or more ceramic elbows of claim 1.
